(19) United States
(12) Patent Application Publication
(10) Pub. No.: US 2008/0055777 A1
(43) Pub. Date: Mar. 6, 2008

(54) Perpendicular magnetic recording media with improved scratch damage performance

(75) Inventors: Shanghsien (Alex) Rou, Fremont, CA (US); Qixu (David) Chen, Milpitas, CA (US); Raj N. Thangaraj, Fremont, CA (US); Huan Tang, Los Altos, CA (US); Xinwei Li, Fremont, CA (US); Jing Gui, Fremont, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC

(21) Appl. No.: 11/515,752

(22) Filed: Sep. 6, 2006

(51) Int. Cl. G11B 5/82

(52) U.S. Cl. 360/135

(57) ABSTRACT

A scratch erasure resistant perpendicular magnetic recording medium comprises a non-magnetic substrate having a surface, and a layer stack formed over the surface and comprising: (i) at least one magnetically hard perpendicular magnetic recording layer; and (ii) at least one low shear modulus layer comprising at least one material having a shear modulus not greater than about 30 GPa. Preferably, the at least one magnetically hard perpendicular magnetic recording layer includes at least a first layer comprised of a magnetic material having a hexagonal close packed (hcp) crystal structure and <0001> preferred basal plane crystallographic orientation with c-axis perpendicular to a surface thereof.

### FIELD OF THE INVENTION

The present invention relates to improved, scratch damage resistant, magnetic recording media. The invention has particular utility in the manufacture and design of high performance, high areal recording density magnetic media, such as hard disks, comprising perpendicular magnetic recording layers.

### BACKGROUND OF THE INVENTION

Magnetic media are widely used in various applications, particularly in the computer industry for data/information storage and retrieval applications, typically in disk form, and efforts are continually made with the aim of increasing the areal recording density, i.e., bit density of the magnetic media. Conventional thin-film type magnetic media, wherein a fine-grained polycrystalline magnetic alloy layer serves as the active recording layer, are generally classified as “longitudinal” or “perpendicular”, depending upon the orientation of the residual magnetization of the grains of the magnetic material.

Perpendicular recording media have been found to be superior to longitudinal media in achieving very high bit densities without experiencing the thermal stability limit associated with the latter. In perpendicular magnetic recording media, residual magnetization is formed in a direction (“easy axis”) perpendicular to the surface of the magnetic medium, typically a layer of a magnetic material on a suitable substrate. Very high to ultra-high linear recording densities are obtainable by utilizing a “single-pole” magnetic transducer or “head” with such perpendicular magnetic media.

At present, efficient, high bit density recording utilizing a perpendicular magnetic medium requires interposition of a relatively thick (as compared with the magnetic recording layer), magnetically “soft” underlayer (“SUL”), i.e., a magnetic layer having a relatively low coercivity typically not greater than about 1 kOe, such as of a NiFe alloy (Permalloy), between a non-magnetic substrate, e.g., of glass, aluminum (Al) or an Al-based alloy, and a magnetically “hard” recording layer having relatively high coercivity, typically about 3-8 kOe, e.g., of a cobalt-based alloy (e.g., a Co—Cr alloy such as CoCrPtB) having perpendicular anisotropy. The magnetically soft underlayer serves to guide magnetic flux emanating from the head through the magnetically hard perpendicular recording layer.

A conventionally structured perpendicular recording system 10 with a perpendicularly oriented magnetic medium 1 and a magnetic transducer head 9 is schematically illustrated in cross-section in FIG. 1, wherein reference numeral 2 indicates a non-magnetic substrate, reference numeral 3 indicates an optional adhesion layer, reference numeral 4 indicates a relatively thick magnetically soft underlayer (SUL), reference numeral 5 indicates an “intermediate” layer stack 5 which may include at least one non-magnetic interlayer 5_{B} of a hcp material adjacent the magnetically hard perpendicular recording layer 6 and an optional seed layer 5_{A} adjacent the magnetically soft underlayer (SUL) 4, comprising at least one of an amorphous material and an fcc material, and reference numeral 6 indicates at least one relatively thin magnetically hard perpendicular recording layer with its magnetic easy axis perpendicular to the film plane.

Still referring to FIG. 1, reference numerals 9_{M} and 9_{A}, respectively, indicate the main (writing) and auxiliary poles of the magnetic transducer head 9. The relatively thin interlayer 5, comprised of one or more layers of non-magnetic materials, serves to (1) prevent magnetic interaction between the magnetically soft underlayer (SUL) 4 and the at least one magnetically hard recording layer 6; and (2) promote desired microstructural and magnetic properties of the at least one magnetically hard recording layer 6.

As shown by the arrows in the figure indicating the path of the magnetic flux φ, flux φ emanates from the main writing pole 9_{M} of magnetic transducer head 9, enters and passes through the at least one vertically oriented, magnetically hard recording layer 6 in the region below main pole 9_{M}, enters and travels within soft magnetic underlayer (SUL) 4 for a distance, and then exits therefrom and passes through the at least one perpendicular hard magnetic recording layer 6 in the region below auxiliary pole 9_{A} of transducer head 9. The direction of movement of perpendicular magnetic medium 21 past transducer head 9 is indicated by the arrow in the figure.

Completing the layer stack of medium 1 is a protective overcoat layer 7, such as of a diamond-like carbon (DLC), formed over magnetically hard layer 6, and a lubricant topcoat layer 8, such as of a perfluoropolyether (PFPE) material, formed over the protective overcoat layer.

Substrate 2, in hard disk applications, is disk-shaped and comprised of a non-magnetic metal or alloy, e.g., Al or an Al-based alloy, such as Al—Mg having a Ni—P plating layer on the deposition surface thereof, or alternatively, substrate 2 is comprised of a suitable glass, ceramic, glass-ceramic, polymeric material, or a composite or laminate of these materials. Optional adhesion layer 3, if present on substrate surface 2, may comprise a less than about 200 Å thick layer of a metal or a metal alloy material such as Ti, a Ti-based alloy, Ta, a Ta-based alloy, Cr, or a Cr-based alloy. The relatively thick soft magnetic underlayer 4 may be comprised of an about 50 to about 300 nm thick layer of a soft magnetic material such as Ni, Co, Fe, an Fe-containing alloy such as NiFe (Permalloy), FeN, FeSiAl, FeSiAlN, FeTaC, a Co-containing alloy such as CoZr, CoZrCr, CoZrNb, or a Co—Fe-containing alloy such as CoFeZrNb, CoFeZrTa, CoFe, FeCoB, FeCoCrB, and FeCoC. Relatively thin intermediate layer stack 5 may comprise an about 50 to about 300 Å thick layer or layers of non-magnetic material(s). Intermediate layer stack 5 includes at least one non-magnetic interlayer 5_{B} of a hcp material, such as Ru, TiCr, Ru/CoCr₃₇Pt₆, RuCr/CoCrPt, etc., adjacent the magnetically hard perpendicular recording layer 6. When present, seed layer 5_{A} adjacent the magnetically soft underlayer (SUL) 4 may comprise a less than about 100 Å thick layer of an fcc material, such as an alloy of Cu, Ag, Pt, or Au, or a material such as Ta, TaW, CrTa, Ti, TiN, TiW, or TiCr. The at least one magnetically hard perpendicular recording layer 6 preferably comprises a high coercivity magnetic alloy with a hexagonal close-packed (hcp) <0001> basal plane crystal structure with uniaxial crystalline anisotropy and magnetic easy axis (c-axis) oriented perpendicular to the surface of the magnetic layer or film. Such magnetically hard perpendicular recording layers typically comprise an about 6 to about 25 nm thick layer(s) of Co-based alloy(s) including one or more elements selected from the group consisting of Cr, Fe, Ta, Ni, Mo, Pt, W, Cr, Ru, Ti, Si, O, V, Nb, Ge, B, and Pd.

In practice, however, perpendicular media comprising hcp structured magnetically hard recording layers have been susceptible to scratch erasure. The latter term refers to a phenomenon wherein unrecoverable errors in recorded data occur when magnetic media, e.g., hard disks, are subjected to extreme mechanical stress or shear conditions, such as scratching of the media surface. Scratching of the media surface can occur because the magnetic transducer (i.e., read/write head) flies over the surface of the rotating media at extremely low flying heights. As a consequence, even minute particles present in the hard disk drive, especially on the media or head surfaces, may scratch the media surface. Such scratches may result in permanent, i.e., unrecoverable, magnetic signal loss or errors even in instances where the scratch process has not caused physical removal of the magnetic material.

As indicated above, perpendicular magnetic recording media comprise magnetic recording layers having perpendicular magnetic anisotropy, and typically utilize magnetic materials with hcp crystal structure with c-axis perpendicular to the film surface. Extensive studies by the present inventors have determined that scratch erasure results from a permanent change or alteration in a magnetic property, e.g., coercivity H_{c}, of the magnetic recording layer under extreme mechanic stress conditions. The scratch-damaged region(s) of the magnetic recording film or layer is (are) unwritable or unrewritable and therefore unable to serve the intended purpose of magnetic recording.

In view of the foregoing, there exists a clear need for improved, scratch damage resistant perpendicular magnetic recording media which function in optimal fashion under operating conditions where scratch erasure occurs with conventional perpendicular media and thereby provide a full range of benefits and performance enhancement vis-à-vis conventional longitudinal media and systems, consistent with expectation afforded by adoption of perpendicular media as an industry standard in computer-related applications.

### SUMMARY OF THE INVENTION

An advantage of the present invention is improved, scratch erasure resistant, perpendicular magnetic recording media.

Another advantage of the present invention is a method of fabricating improved, scratch erasure resistant, perpendicular magnetic recording media.

Additional advantages and other features of the present invention will be set forth in the description which follows and in part will become apparent to those having ordinary skill in the art upon examination of the following or may be learned from the practice of the present invention. The advantages of the present invention may be realized and obtained as particularly pointed out in the appended claims.

According to an aspect of the present invention, the foregoing and other advantages are obtained in part by an improved perpendicular magnetic recording medium, comprising:

a) a non-magnetic substrate having a surface; and

b) a layer stack formed over the substrate surface, the layer stack comprising:
(i) at least one magnetically hard perpendicular magnetic recording layer; and
(ii) at least one low shear modulus layer, wherein:

the at least one low shear modulus layer comprises at least one material having a shear modulus not greater than about 30 GPa and provides the medium with scratch damage resistance.

Preferably, the at least one magnetically hard perpendicular magnetic recording layer includes at least a first layer comprised of a magnetic material having a hexagonal close packed (hcp) crystal structure and <0001> preferred basal plane crystallographic orientation with c-axis perpendicular to a surface thereof. Typically, the first layer comprises a Co-based alloy material, preferably a granular material.

According to embodiments of the present invention, the at least one magnetically hard perpendicular magnetic recording layer includes a second layer comprised of a multilayer superlattice magnetic material. Preferably, the second layer comprises alternating thin Co or Co-based alloy layers about 3 Å thick and Pd or Pt or Pd- or Pt-based alloy layers up to about 15 Å thick.

In accordance with embodiments of the present invention, the at least one low shear modulus layer is from about 2.5 to about 1,000 nm thick, preferably from about 10 to about 20 nm thick, and comprised of at least one of gold and silver.

Preferred embodiments of the present invention include those wherein the layer stack includes a protective overcoat layer over the at least one perpendicular magnetic recording layer, and the at least one low shear modulus layer is positioned between the protective overcoat layer and the at least one perpendicular magnetic recording layer.

Further embodiments of the present invention include those wherein the layer stack includes a magnetically soft underlayer (SUL) between the substrate surface and the at least one perpendicular magnetic recording layer, and the at least one low shear modulus layer is positioned between the substrate surface and the SUL or between the SUL and the at least one perpendicular magnetic recording layer.

Still further embodiments of the present invention include those wherein the layer stack includes an intermediate layer comprising at least one of a non-magnetic interlayer and a seed layer between the substrate surface and the at least one perpendicular magnetic recording layer, and the at least one low shear modulus layer is positioned between the substrate surface and the intermediate layer or between the one intermediate layer and the at least one perpendicular magnetic recording layer.

Another aspect of the present invention is a method of fabricating an improved perpendicular magnetic recording medium, comprising steps of:

(a) providing a non-magnetic substrate having a surface; and

(b) forming a stack of thin film layers over the substrate surface, the layer stack comprising:
(i) at least one magnetically hard perpendicular magnetic recording layer; and
(ii) at least one low shear modulus layer, wherein:

the at least one low shear modulus layer comprises at least one material having a shear modulus not greater than about 30 GPa and provides the medium with scratch damage resistance.

Preferably, step (b) comprises forming the at least one magnetically hard perpendicular magnetic recording layer to include at least a first layer comprised of a magnetic material having a hexagonal close packed (hcp) crystal structure and <0001> preferred basal plane crystallographic orientation with c-axis perpendicular to a surface thereof. Typically, the first layer comprises a Co-based alloy material, preferably a granular material.

According to embodiments of the present invention, step (b) comprises forming the at least one magnetically hard perpendicular magnetic recording layer to include a second layer comprised of a multilayer superlattice magnetic material. Preferably, the second layer comprises alternating thin Co or Co-based alloy layers about 3 Å thick and Pd or Pt or Pd- or Pt-based alloy layers up to about 15 Å thick.

In accordance with embodiments of the present invention, step (b) includes forming the at least one low shear modulus layer at a thickness from about 2.5 to about 1,000 nm, preferably at a thickness from about 10 to about 20 nm, and comprised of at least one of gold and silver.

Preferred embodiments of the present invention include those wherein step (b) comprises forming the layer stack to include a protective overcoat layer over the at least one perpendicular magnetic recording layer, and the at least one low shear modulus layer is positioned between the protective overcoat layer and the at least one perpendicular magnetic recording layer.

Further embodiments of the present invention include those wherein step (b) comprises forming the layer stack to include a magnetically soft underlayer (SUL) between the substrate surface and the at least one perpendicular magnetic recording layer, and the at least one low shear modulus layer is positioned between the substrate surface and the SUL or between the SUL and the at least one perpendicular magnetic recording layer.

Still further embodiments of the present invention include those wherein step (b) comprises forming the layer stack to include an intermediate layer comprising at least one of a non-magnetic interlayer and a seed layer between the substrate surface and the at least one perpendicular magnetic recording layer, and the at least one low shear modulus layer is positioned between the substrate surface and the at least one intermediate layer or between the at least one intermediate layer and the at least one perpendicular magnetic recording layer.

Yet another aspect of the present invention is a scratch damage resistant perpendicular magnetic recording medium, comprising:

(a) a non-magnetic substrate having a surface; and

(b) a layer stack formed over the substrate surface, the layer stack comprising:
(i) a first magnetically hard perpendicular magnetic recording layer comprised of a magnetic material having a hexagonal close-packed (hcp) crystal structure and <0001> preferred basal plane crystallographic orientation with c-axis perpendicular to a surface thereof; and
(ii) a magnetically hard perpendicular magnetic recording layer comprised of a multilayer superlattice magnetic material.

Preferred embodiments of the present invention include those wherein the first magnetically hard perpendicular magnetic recording layer comprises a Co-based alloy material or a granular material, and the second magnetically hard perpendicular magnetic recording layer overlies the first magnetically hard perpendicular magnetic recording layer and comprises alternating thin Co or Co-based alloy layers about 3 Å thick and Pd or Pt or Pd- or Pt-based alloy layers up to about 15 Å thick.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the same reference numerals are employed throughout for designating the same or similar features, and wherein the various features are not necessarily drawn to scale but rather are drawn as to best illustrate the pertinent features, wherein:

FIG. 1 schematically illustrates, in simplified cross-sectional view, a portion of a conventional magnetic recording, storage, and retrieval system comprised of a conventionally structured perpendicular magnetic recording medium and a single-pole magnetic transducer head;

FIG. 2 is a graph for illustrating the variation of the signal from a MFM (magnetic force microscopy) probe along the width of a scratch made in a written track of a perpendicular magnetic recording medium;

FIG. 3 is a graph providing a comparison of scratch-induced coercivity (H_{c}) degradation of longitudinal and perpendicular magnetic recording media;

FIG. 4 is a graph showing a comparison of the scratch damage performance as a function of the scratch load for various types of magnetic recording media; and

FIGS. 5-10 schematically illustrate, in simplified cross-sectional view, portions of examples of embodiments of scratch damage resistant perpendicular magnetic recording media according to the present invention.

### DESCRIPTION OF THE INVENTION

The present invention addresses and effectively solves, or at least mitigates, drawbacks and disadvantages associated with the use of high performance, high areal density perpendicular magnetic recording media in applications where the media surface is subject to hard particle-induced scratching during use, e.g., as in hard disk drive systems utilizing transducer heads operating at very low flying heights. Specifically, the present inventors have determined that minute particles present in the hard disk drive, especially on the media or head surfaces, may scratch the media surface. Such scratches may result in permanent, i.e., unrecoverable, magnetic signal loss or errors even in instances where the scratch process has not caused physical removal of the magnetic material.

As indicated above, the phenomenon of scratch erasure is especially notable in perpendicular magnetic recording media comprised of magnetic recording layers having perpendicular magnetic anisotropy, which recording layers typically utilize magnetic materials having a hexagonal close packed (hcp) crystal structure and <0001> preferred basal plane crystallographic orientations with the c-axis perpendicular to the film surface. Extensive studies by the present inventors have determined that scratch erasure results from a permanent change or alteration in a magnetic property, e.g., coercivity H_{c}, of the magnetic recording layer under extreme mechanic stress conditions. The scratch-damaged region(s) of the magnetic recording film or layer is (are) unwritable or unrewritable and therefore unable to serve the intended purpose of magnetic recording.

Briefly stated, the present inventors have determined that thin film perpendicular media with layer stacks including magnetic recording layers with the aforementioned hcp structure and <0001> preferred basal plane crystallographic orientations and provided with at least one low shear modulus layer (i.e., with a shear modulus of about 30 or less) exhibit significantly improved scratch-induced magnetic damage such as data erasure.

In more detail, according to investigations concerning scratch erasure conducted by the instant inventors, after magnetic recording signals were written to the media with wide band signal writers having a track width of 50 μm at a given linear density, e.g., 40 kfci, “Hysitron” technique scratches were made on the recorded regions at several normal loads with a cube-cornered diamond tip. (According to the “Hysitron” technique, a Hysitron system, which is a nano-indentation/nano-scratching apparatus, is utilized for forming a series of nano-scratches on the medium surface under controlled load forces typically ranging from a few tens of micro-Newtons, μN, to a few hundreds of μN. By using an appropriately sized nano-indentor, e.g., with a radius of curvature of a few hundred nm, nano-scratches of depth≧1 nm and width≧100 nm can be formed which effectively replicate actual hard particle-induced scratches during media operation). It was observed that the polarity of the recorded magnetic signal around the center of the scratch was reversed when the applied load was sufficiently great.

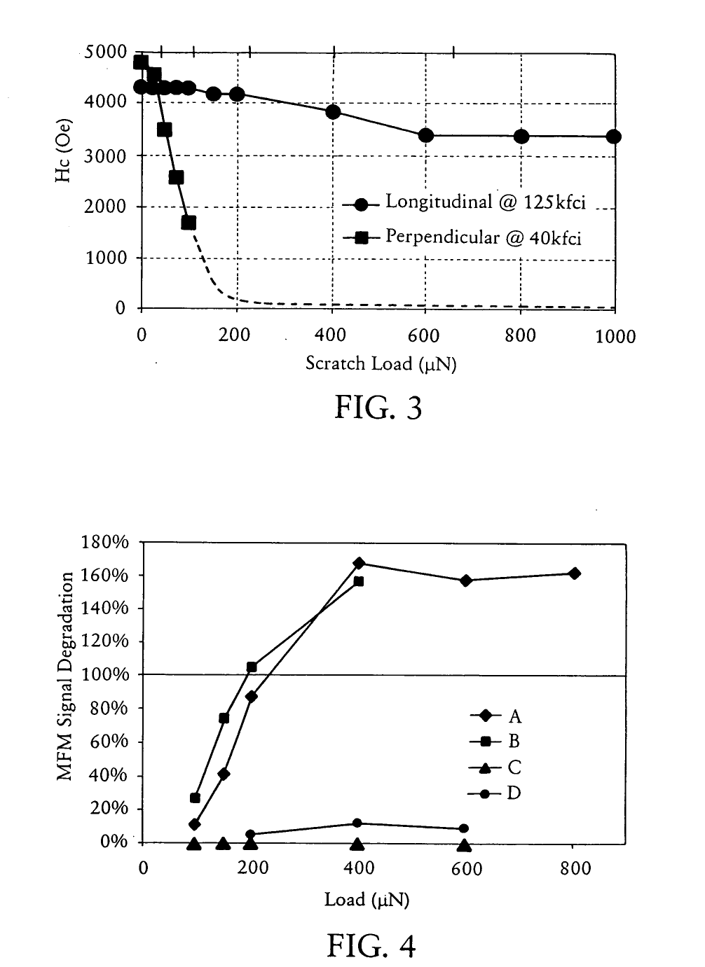

Referring to FIG. 2, graphically illustrated therein is the variation of the signal from a MFM (magnetic force microscopy) probe along the width of a scratch made in a written track, showing the reversal of the polarity of the recorded magnetic signal along the width of the scratch. Polarity reversal is seen to occur around the center of the scratch.

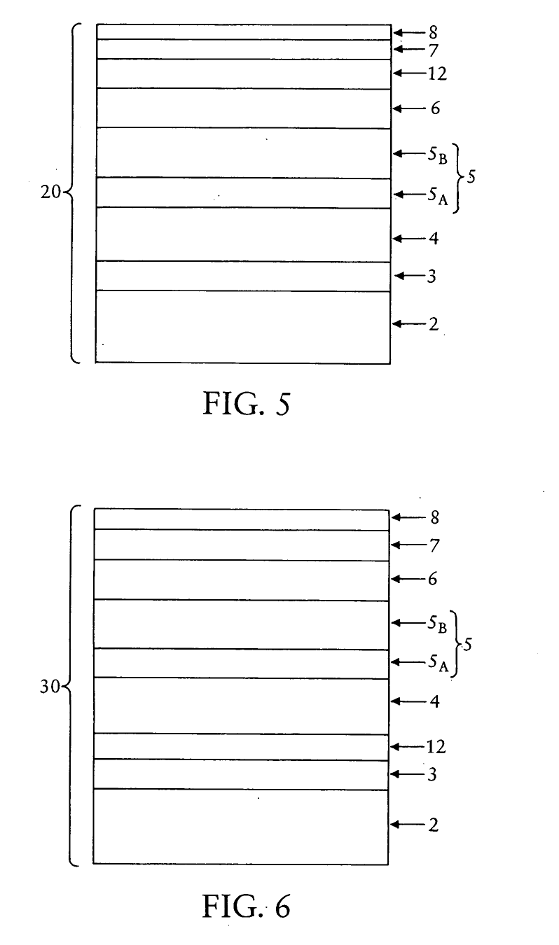

Adverting to FIG. 3, shown therein is a graph providing a comparison of scratch-induced coercivity (H_{c}) degradation of longitudinal and perpendicular magnetic recording media, from which it is evident that the latter type media are substantially more susceptible to hard particle scratch damage than longitudinal media. More specifically, the magnetic properties and electrical performance of the tested perpendicular media start to deteriorate at a significantly lower normal load (stress level) than the tested longitudinal media. For example, H_{c} for perpendicular evidences a reduction commencing at about 25 μN, whereas H_{c} for longitudinal media commences reduction at about 150 μN. Maximum degradation of H_{c} may reach almost 100% at a load of about 200 μN for the tested perpendicular media; whereas H_{c} reduction for longitudinal media reaches a maximum of about 20% at a load of about 600-1,000 μN. It is further observed that all types of hard particles, including those of stainless steel, SiO₂, TiO₂, ZrO₂, Si₃N₄, Al₂O₃, TiC, and SiC pose a reliability/performance risk for perpendicular media.

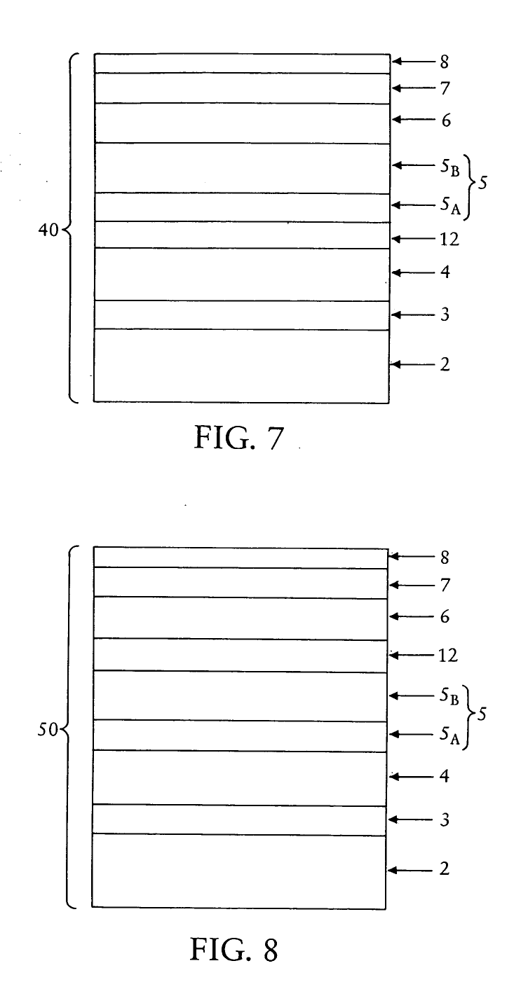

It has been further determined that poor scratch damage performance, relative to longitudinal magnetic recording media, is not characteristic of all perpendicular media. The perpendicular media illustrated in FIGS. 2 and 3 each comprise magnetically hard perpendicular recording layers with hcp structure and <0001> preferred basal plane crystallographic orientations. Referring to FIG. 4, graphically illustrated therein is a comparison of the scratch damage performance (expressed in terms of % MFM signal degradation) as a function of the scratch load (expressed in μN) for various types of magnetic recording media. More specifically, line A indicates the scratch damage performance of granular perpendicular media formed on glass substrates and comprising recording layers with hcp structure and <0001> preferred basal plane crystallographic orientations; line B indicates the scratch damage performance of similar granular perpendicular media formed on aluminum substrates; line C indicates the scratch damage performance of multilayer perpendicular media formed on glass substrates and comprising recording layers with face-centered cubic (fcc) structure and <111> crystallographic orientations and formed of alternating thin Co or Co-based alloy layers ˜3 Å thick and up to about 15 Å thick Pd or Pt or Pd- or Pt-based alloy layers; and line D indicates the scratch damage performance of longitudinal media formed on glass substrates. As clearly demonstrated therein, the multilayer perpendicular magnetic recording media with magnetic recording layers with fcc structure and <111> crystallographic orientations are completely immune to scratch damage, whereas the perpendicular media with granular magnetic recording layers comprising recording layers with hcp structure and <0001> preferred basal plane crystallographic orientations are subject to significant performance degradation (scratch damage).

While not desirous of being bound by any particular theory, it is nonetheless believed that the increased susceptibility to scratch damage evidenced by perpendicular media with hcp-structured magnetic recording layers arises from the perpendicular c-axis orientation of the hcp Co-alloy crystal lattice. In perpendicular media, the hcp <0001> basal planes are parallel to the media growth plane and more readily experience slip under shear stress, thereby leading to a loss of hcp crystal orientation. The loss of hcp crystal orientation in turn leads to loss of the magneto-crystalline anisotropy with a dramatic reduction in coercivity H_{c}. By contrast, due to their more favorable crystalline orientation, longitudinal media are more robust than perpendicular media in terms of shear stress-induced loss of hcp crystallinity and H_{c} degradation. MFM signal reversal in FIG. 4 is considered to result from the dipolar field from intact magnetic moments present in the adjacent areas which cause the degraded magnetic film to polarize in the opposite direction.

The present inventors have determined that thin film perpendicular media with layer stacks magnetic recording layers including hcp structure and <0001> preferred basal plane crystallographic orientations and at least one low shear modulus layer (i.e., with a shear modulus of about 30 or less) exhibit significantly improved scratch-induced magnetic damage performance. Referring to Table I below, shown therein are pertinent mechanical properties of two illustrative, but non-limitative, examples of low shear modulus materials, i.e., silver (Ag) and gold (Au), as well as an illustrative, but non-limitative, example of a comparatively higher shear modulus material, i.e., copper (Cu).

TABLE I

| Mechanical Property | Gold (Au) | Silver (Ag) | Copper (Cu) |
|---|---|---|---|
| Hardness, Vickers (kg/mm²) | 22 | 26 | 50 |
| Tensile Strength, Ultimate | 120 | 140 | 210 |
| (MPa) | | | |
| Modulus of Elasticity (GPa) | 77.2 | 76 | 110 |
| Poisson's Ratio | 0.42 | 0.39 | 0.343 |
| Shear Modulus (GPa) | 27.2 | 27.8 | 46 |

By way of illustration only, granular perpendicular media comprising layer stacks including a magnetic recording layer with hcp structure and <0001> preferred basal plane crystallographic orientation and a silver (Ag) layer as a low shear modulus cap layer between the recording layer and the protective overcoat layer were fabricated and evaluated for scratch erasure resistance via the aforementioned Hysitron scratch technique. Table II below presents a comparison of the results of determination of the critical scratch load (in μN) for phase reversal of the magnetic signal as a function of thickness of the Ag cap layer, from which it is clearly evident that the presence of at least one low shear modulus layer in the layer stack of perpendicular media results in a significant improvement in scratch damage performance.

TABLE II

| | Ag Layer | Min. Load for Phase |
|---|---|---|
| Sample ID | Thickness (nm) | Reversal (μN) |
| T71 | 0 | 100 |
| T72 | 2.5 | 150 |
| T73 | 5 | 400 |

According to the invention, the use of low shear modulus layers for mitigating the performance reduction of perpendicular media arising from scratch damage is not limited to the illustrated case where the low shear modulus layer is present in the layer stack as a cap layer between the recording layer and the protective overcoat layer; rather, the at least one low shear modulus layer may be present at a number of different locations within the layer stack, e.g., between the substrate and the overlying magnetically soft underlayer (SUL), between the SUL and the overlying at least one interlayer, between the at least one interlayer and the overlying magnetic recording layer, etc. The at least one low shear modulus layer may comprise more than one low shear modulus material, e.g., an alloy or other composite or laminate of Ag and Au, and the thickness thereof may range from about 2.5 to about 1000 nm, and is preferably from about 10 to about 20 nm.

Further according to the invention, the layer stack may comprise a combination of magnetic recording layer types, e.g., a layer stack including a granular perpendicular magnetic recording layer having hcp structure and <0001> preferred basal plane crystallographic orientation and an overlying multilayer perpendicular magnetic recording layer such as described above, e.g., formed of alternating thin Co or Co-based alloy layers about 3 Å thick and Pd or Pt or Pd- or Pt-based alloy layers up to about 15 Å thick. According to these embodiments, the low shear modulus layer may be placed at any of the aforementioned locations in the layer stack. The combination of granular and multilayer perpendicular magnetic recording layers according to these embodiments affords benefits in both improved scratch damage performance, relative to conventional granular perpendicular magnetic recording media, and improved magnetic recording performance characteristics compared to those of single layer granular media and multilayer media.

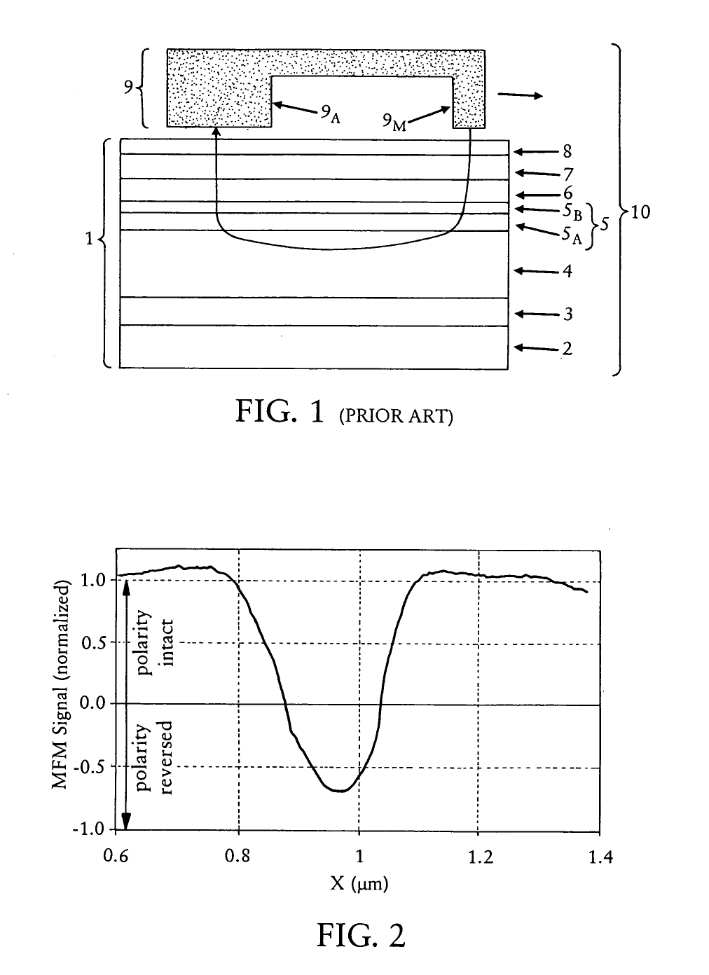

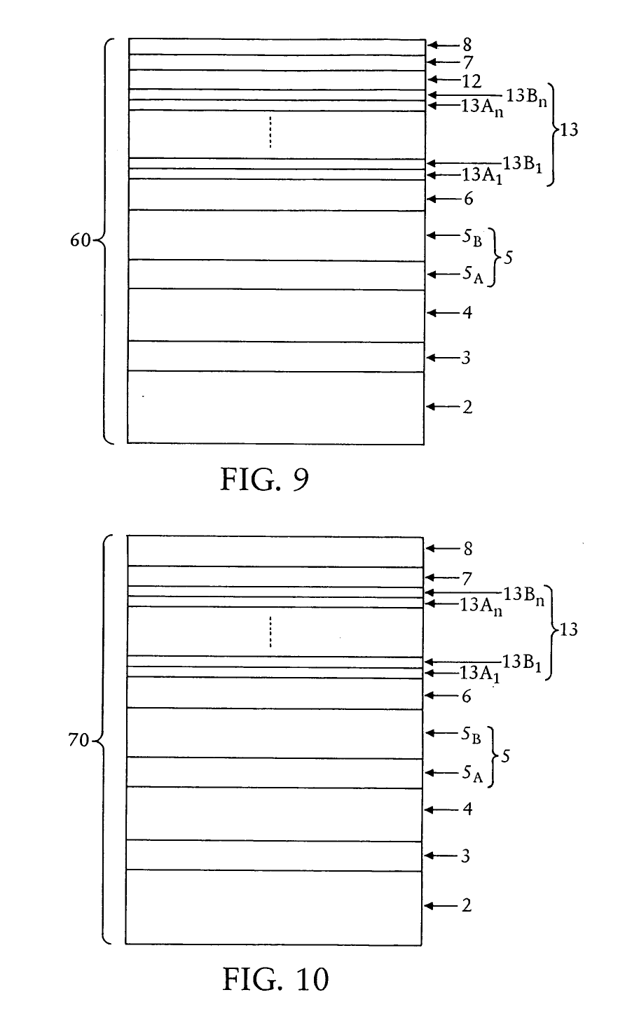

Several illustrative, but non-limitative, examples of embodiments of perpendicular media fabricated according to the principles of the present invention will now be described with reference to FIGS. 5-10. The media of each of the illustrated embodiments are generally similarly structured as medium 1 shown in FIG. 1 and described above, but differ in essential respect(s) as described below.

Referring to FIG. 5, shown therein, in simplified cross-sectional view, is a portion of a first illustrative, but non-limitative example of an embodiment of a scratch damage resistant perpendicular magnetic recording medium 20 structured according to the present invention, wherein a layer 12 of a material having a low shear modulus not greater than about 30 GPa and a thickness from about 2.5 to about 1,000 nm, preferably a thickness from about 10 to about 20 nm, e.g., comprised of gold and/or silver, is positioned in the layer stack between the at least one magnetically hard perpendicular recording layer 6 and protective overcoat layer 7. As indicated in the data of Table II and described above, granular perpendicular media comprising layer stacks including a magnetic recording layer 6 with hcp structure and <0001> preferred basal plane crystallographic orientation and a silver (Ag) layer as a low shear modulus cap layer 12 between the recording layer 6 and the protective overcoat layer 7 demonstrate a significant improvement in scratch damage performance.

FIGS. 6 and 7 illustrate, in simplified cross-sectional view, further examples of embodiments of scratch damage resistant perpendicular magnetic recording media structured according to the present invention. In medium 30 shown in FIG. 6 a layer 12 of low shear modulus material is positioned between substrate 2 and SUL 4 and in medium 40 shown in FIG. 7 a layer 12 of low shear modulus material is positioned between SUL 4 and intermediate layer 5. (Alternatively, medium 40 of FIG. 7 may be viewed as illustrating an embodiment of a medium structured according to the present invention, wherein layer 12 of low shear modulus material is positioned between SUL 4 and intermediate layer 5).

Yet another example of an embodiment of a scratch damage resistant perpendicular magnetic recording medium 50 is shown, in simplified cross-sectional view, in FIG. 8, wherein layer 12 of low shear modulus material is positioned between intermediate layer 5 and magnetically hard perpendicular recording layer 6.

Referring now to FIG. 9, illustrated therein, in simplified cross-sectional view, is a still further example of an embodiment of a scratch damage resistant perpendicular magnetic recording medium 60 according to the present invention which generally resembles medium 20 shown in FIG. 5, but comprises a second, multilayer perpendicular magnetic recording layer 13 in overlying contact with (first) perpendicular magnetic recording layer 6 (e.g., a hcp structured granular layer). A low shear modulus layer 12 is positioned in the stack between the second magnetic recording layer 13 and the protective overcoat layer 7. As indicated supra, a layer stack including a combination of a granular perpendicular magnetic recording layer having hcp structure and <0001> preferred basal plane crystallographic orientation and an overlying multilayer superlattice perpendicular magnetic recording layer, e.g., formed of alternating thin Co or Co-based alloy layers about 3 Å thick and Pd or Pt or Pd- or Pt-based alloy layers up to about 15 Å thick, affords benefits in both improved scratch erasure performance, relative to conventional granular perpendicular magnetic recording media, and improved magnetic recording performance characteristics compared to those of single layer granular media and multilayer media. It should also be noted that placement of the low shear modulus layer 12 is not limited to the location in the layer stack shown in medium 60; rather, layer 12 may be placed in any of the locations in the layer stacks shown in FIGS. 5-8.

With reference to FIG. 10, illustrated therein, in simplified cross-sectional view, is yet another example of an embodiment of a scratch erasure-resistant perpendicular magnetic recording medium 70 according to the present invention which resembles medium 60 shown in FIG. 9 and comprises a second, multilayer perpendicular magnetic recording layer 13 in overlying contact with (first) perpendicular magnetic recording layer 6 (e.g., a hcp structured granular layer). However, in contrast with medium 60 of FIG. 9, a low shear modulus layer 12 is not present in the stack. between the second magnetic recording layer 13 and the protective overcoat layer 7. The layer stack including a combination of a granular perpendicular magnetic recording layer having hcp structure and <0001> preferred basal plane crystallographic orientation and an overlying multilayer superlattice perpendicular magnetic recording layer, e.g., formed of alternating thin Co or Co-based alloy layers about 3 Å thick and Pd or Pt or Pd- or Pt-based alloy layers up to about 15 Å thick, affords benefits in both improved scratch erasure performance, relative to conventional granular perpendicular magnetic recording media, even without a low shear modulus layer 12. In addition, such combined structure affords improved magnetic recording performance characteristics compared to those of single layer granular media and multilayer media.

As has been indicated, media 20-70 according to the present invention generally resemble the conventional perpendicular medium 1 of FIG. 1, and comprise a series of thin film layers arranged in an overlying (i.e., stacked) sequence on a non-magnetic substrate 2 comprised of a non-magnetic material selected from the group consisting of: Al, Al—Mg alloys, other Al-based alloys, NiP-plated Al or Al-based alloys, glass, ceramics, glass-ceramics, polymeric materials, and composites or laminates of these materials.

The thickness of substrate 2 is not critical; however, in the case of magnetic recording media for use in hard disk applications, substrate 2 must be of a thickness sufficient to provide the necessary rigidity. Substrate 2 typically comprises Al or an Al-based alloy, e.g., an Al—Mg alloy, or glass or glass-ceramics, and, in the case of Al-based substrates, includes a plating layer, typically of NiP, on the surface of substrate 2 (not shown in the figure for illustrative simplicity). An optional adhesion layer 3, typically a less than about 100 Å thick layer of a metal or a metal alloy material, e.g., Ti, a Ti-based alloy, Ta, a Ta-based alloy, Cr, or a Cr-based alloy, may be formed over the surface of substrate surface 2 or the NiP plating layer thereon.

Overlying substrate 2 or optional adhesion layer 3 is a magnetically soft underlayer (SUL) 4 which comprises a layer of a soft, low coercivity magnetic material (or a laminate of layers of a soft material with spacer layers of a non-magnetic material) from about 50 to about 300 nm thick. Suitable magnetically soft, low coercivity materials for use as SUL 4 include, but are not limited to, FeCoB, FeCoCrB, CoZrNb, CoZrTa, FeCoTaZr, FeCoZrNb, and FeTaC.

As in medium 1 shown in FIG. 1, an optional adhesion layer 3 may be included in the layer stack of media 20-70 between the surface of substrate 2 and the SUL 4, the adhesion layer 3 being less than about 200 Å thick and comprised of a metal or a metal alloy material such as Ti, a Ti-based alloy, Ta, a Ta-based alloy, Cr, or a Cr-based alloy.

Also as in medium 1, the layer stacks of media 20-70 according to the present invention further comprise an intermediate layer stack 5 between SUL 4 and at least one overlying perpendicular magnetic recording layer 6, which intermediate layer stack 5 is comprised of optional seed layer 5_{A}, and interlayer 5_{B} for facilitating a preferred perpendicular growth orientation and grain size of the overlying at least one perpendicular magnetic recording layer 6, as well as for magnetically decoupling the SUL and magnetic recording layers. Suitable non-magnetic materials for use as interlayer 5_{B} adjacent the magnetically hard perpendicular recording layer 6 include hcp-structured materials, such as Ru, TiCr, CoCr, CoCrRu, Ru/CoCr₃₇Pt₆, RuCr/CoCrPt, etc.; suitable materials for use as optional seed layer 5_{A} typically include an fcc material, such as an alloy of Cu, Ag, Pt, or Au, or an amorphous or fine-grained material, such as Ta, TaW, CrTa, Ti, TiN, TiW, or TiCr.

The magnetically hard perpendicular magnetic recording layer 6 is preferably comprised of one or more layers of a Co-based alloy including one or more elements selected from the group consisting of Cr, Fe, Ta, Ni, Mo, Pt, W, Cr, Ru, Ti, Si, O, V, Nb, Ge, B, and Pd. Exemplary alloys include CoCr, CoCrPt, CoCrPtB, CoCrPtSiO₂, CoCrPtTiO₂, CoCrPtTa₂O₅, and CoCrPtNb₂O₅. Preferably, the at least one perpendicular magnetic recording layer 6 comprises an hcp Co-based alloy with a <0001> preferred basal plane and preferred c-axis perpendicular growth orientations; and the interlayer stack 5 comprises an hcp material with a preferred c-axis perpendicular growth orientation. In addition, the at least one perpendicular magnetic recording layer 6 is preferably granular, i.e., comprised of at least partially isolated, uniformly sized and composed, magnetic particles or grains with c-axis growth orientation.

As for medium 60 and 70 shown in FIGS. 9-10, which comprise a second, multilayer superlattice perpendicular magnetic recording layer 13 in overlying contact with (first) perpendicular magnetic recording layer 6, the multilayer magnetic superlattice 13 is typically comprised of a plurality (i.e., n) of pairs of Co or Co-based layers 13Aₙ and Pd or Pt or Pd- or Pt-based layers 13Bₙ, wherein n ranges from 2 to about 20. Preferably, each of the Co or Co-based layers 13Aₙ is about 3 Å thick and comprised of Co or a Co-based alloy such as CoCr, CoB, CoCrB, CoC, etc., and each of the Pd or Pt or Pd- or Pt-based layers 13Bₙ is up to about 15 Å thick and comprised of Pd or Pt or a Pd- or Pt-based alloy such as PdB, PtB, PdC, PtC, PdSiO₂, PtSiO₂, etc.

Finally, the layer stack of each of media 20-70 includes a protective overcoat layer 7 above the at least one perpendicular magnetic recording layer 6 and a lubricant topcoat layer 8 over the protective overcoat layer 7. Preferably, the protective overcoat layer 7 comprises a carbon-based material, e.g., diamond-like carbon (“DLC”), and the lubricant topcoat layer 8 comprises a fluoropolymer material, e.g., a perfluoropolyether compound.

According to the invention, each of the layers 3-7, 12, and 13A, 13B may be deposited or otherwise formed by any suitable technique utilized for formation of thin film layers, e.g., any suitable physical vapor deposition (“PVD”) technique, including but not limited to, sputtering, vacuum evaporation, ion plating, cathodic arc deposition (“CAD”), etc., or by any combination of various PVD techniques. The lubricant topcoat layer 8 may be provided over the upper surface of the protective overcoat layer 7 in any convenient manner, e.g., as by dipping the thus-formed medium into a liquid bath containing a solution of the lubricant compound.

Thus, the present invention advantageously provides improved performance, high areal density, magnetic alloy-based perpendicular magnetic media and data/information recording, storage, and retrieval systems, which media afford improved substantially improved scratch damage resistance by virtue of the presence of the at least one low shear modulus layer in the layer stack or by a combination of different types of magnetically hard perpendicular magnetic recording layers. The media of the present invention enjoy particular utility in high recording density systems for computer-related applications. In addition, the inventive media can be fabricated by means of conventional media manufacturing technologies, e.g., sputtering.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

What is claimed is:

1. A perpendicular magnetic recording medium, comprising:
(a) a non-magnetic substrate having a surface; and
(b) a layer stack formed over said substrate surface, said layer stack comprising:
(i) at least one magnetically hard perpendicular magnetic recording layer; and
(ii) at least one low shear modulus layer, wherein:
said at least one low shear modulus layer comprises at least one material having a shear modulus not greater than about 30 GPa and provides said medium with scratch damage resistance.

2. The medium according to claim 1, wherein:
said at least one magnetically hard perpendicular magnetic recording layer includes at least a first layer comprised of a magnetic material having a hexagonal close packed (hcp) crystal structure and <0001> preferred basal plane crystallographic orientation with c-axis perpendicular to a surface thereof.

3. The medium according to claim 2, wherein:
said first layer comprises a Co-based alloy material.

4. The medium according to claim 2, wherein:
said first layer comprises a granular material.

5. The medium according to claim 2, wherein:
said at least one magnetically hard perpendicular magnetic recording layer includes a second layer comprised of a multilayer superlattice magnetic material.

6. The medium according to claim 5, wherein:
said second layer comprises alternating thin Co or Co-based alloy layers about 3 Å thick and Pd or Pt or Pd- or Pt-based alloy layers up to about 15 Å thick.

7. The medium according to claim 1, wherein:
said at least one low shear modulus layer is from about 2.5 to about 1,000 nm thick.

8. The medium according to claim 7, wherein:
said at least one low shear modulus layer is from about 10 to about 20 nm thick.

9. The medium according to claim 7, wherein:
said at least one low shear modulus layer comprises at least one of gold and silver.

10. The medium according to claim 1, wherein:
said layer stack includes a protective overcoat layer over said at least one perpendicular magnetic recording layer, and said at least one low shear modulus layer is positioned between said protective overcoat layer and said at least one perpendicular magnetic recording layer.

11. The medium according to claim 1, wherein:
said layer stack includes a magnetically soft underlayer (SUL) between said substrate surface and said at least one perpendicular magnetic recording layer, and said at least one low shear modulus layer is positioned between said substrate surface and said SUL or between said SUL and said at least one perpendicular magnetic recording layer.

12. The medium according to claim 1, wherein:
said layer stack includes an intermediate layer comprising at least one of a non-magnetic interlayer and a seed layer between said substrate surface and said at least one perpendicular magnetic recording layer, and said at least one low shear modulus layer is positioned between said substrate surface and said intermediate layer or between said intermediate layer and said at least one perpendicular magnetic recording layer.

13. A method of fabricating a perpendicular magnetic recording medium, comprising steps of:
(a) providing a non-magnetic substrate having a surface; and
(b) forming a stack of thin film layers over said substrate surface, said layer stack comprising:
(i) at least one magnetically hard perpendicular magnetic recording layer; and
(ii) at least one low shear modulus layer, wherein:
said at least one low shear modulus layer comprises at least one material having a shear modulus not greater than about 30 GPa and provides said medium with scratch damage resistance.

14. The method as in claim 13, wherein:
step (b) comprises forming said at least one magnetically hard perpendicular magnetic recording layer to include at least a first layer comprised of a magnetic material having a hexagonal close packed (hcp) crystal structure and <0001> preferred basal plane crystallographic orientation with c-axis perpendicular to a surface thereof.

15. The method as in claim 14, wherein:
said first layer comprises a Co-based alloy material.

16. The method as in claim 14, wherein:
said first layer comprises a granular material.

17. The method as in claim 14, wherein:
step (b) comprises forming said at least one magnetically hard perpendicular magnetic recording layer to include a second layer comprised of a multilayer superlattice magnetic material.

18. The method as in claim 17, wherein:
said second layer comprises alternating thin Co or Co-based alloy layers about 3 Å thick and Pd or Pt or Pd- or Pt-based alloy layers up to about 15 Å thick.

19. The method as in claim 13, wherein:
step (b) includes forming said at least one low shear modulus layer at a thickness from about 2.5 to about 1,000 nm.

20. The method as in claim 19, wherein:
step (b) includes forming said at least one low shear modulus layer at a thickness from about 10 to about 20 nm.

21. The method as in claim 19, wherein:
said at least one low shear modulus layer comprises at least one of gold and silver.

22. The method as in claim 13, wherein:
step (b) comprises forming said layer stack to include a protective overcoat layer over said at least one perpendicular magnetic recording layer, and said at least one low shear modulus layer is positioned between said protective overcoat layer and said at least one perpendicular magnetic recording layer.

23. The method as in claim 13, wherein:
step (b) comprises forming said layer stack to include a magnetically soft underlayer (SUL) between said substrate surface and said at least one perpendicular magnetic recording layer, and said at least one low shear modulus layer is positioned between said substrate surface and said SUL or between said SUL and said at least one perpendicular magnetic recording layer.

24. The method as in claim 13, wherein:
step (b) comprises forming said layer stack to include an intermediate layer comprising at least one of a non-magnetic interlayer and a seed layer between said substrate surface and said at least one perpendicular magnetic recording layer, and said at least one low shear modulus layer is positioned between said substrate surface and said intermediate layer or between said intermediate layer and said at least one perpendicular magnetic recording layer.

25. A scratch damage resistant perpendicular magnetic recording medium, comprising:
(a) a non-magnetic substrate having a surface; and
(b) a layer stack formed over said substrate surface, said layer stack comprising:
(i) a first magnetically hard perpendicular magnetic recording layer comprised of a magnetic material having a hexagonal close-packed (hcp) crystal structure and <0001> preferred basal plane crystallographic orientation with c-axis perpendicular to a surface thereof; and
(ii) a magnetically hard perpendicular magnetic recording layer comprised of a multilayer superlattice magnetic material.

26. The medium according to claim 25, wherein:
said first magnetically hard perpendicular magnetic recording layer comprises a Co-based alloy material or a granular material; and
said second magnetically hard perpendicular magnetic recording layer comprises alternating thin Co or Co-based alloy layers about 3 Å thick and Pd or Pt or Pd- or Pt-based alloy layers up to about 15 Å thick.

27. The medium according to claim 26, wherein:
said second magnetically hard perpendicular magnetic recording layer overlies said first magnetically hard perpendicular magnetic recording layer in said layer stack.
